(19) United States
(12) Patent Application Publication
(10) Pub. No.: US 2005/0095051 A1
(43) Pub. Date: May 5, 2005

(54) Coated writing apparatus

(76) Inventor: Alexis Walby, Biloxi, MS (US)

Correspondence Address: RYAN KROMHOLZ & MANION, S.C., POST OFFICE BOX 26618, MILWAUKEE, WI, 53226, US

(21) Appl. No.: 10/972,791

(22) Filed: Oct. 25, 2004

Related U.S. Application Data
(60) Provisional application No. 60/515,488, filed on Oct. 29, 2003.

(51) Int. Cl. B43K 23/00; B43M 11/06; A46B 11/00

(52) U.S. Cl. 401/88; 401/48

(57) ABSTRACT

Chalk or other messy writing material is coated with wax or another easily applied material to the writing material, preventing the writing material from creating an undesirable mess.

### RELATED APPLICATION

This application claims the benefit of U.S. Provisional Patent Application Ser. No. 60/515,488, filed 29 Oct. 2003, and entitled “Coated Writing Apparatus.”

### BACKGROUND OF THE INVENTION

This invention relates to sidewalk chalk, commonly used by children as a recreational or artistic pastime. Such chalk can create a serious mess on the clothing and skin of the children.

### SUMMARY OF THE INVENTION

This invention is a novel method and apparatus for sidewalk writing, or other uses as the user may see fit. The invention comprises chalk coated with wax or another easily applied material to the chalk, which prevents the chalk from creating the aforesaid serious mess.

### BRIEF DESCRIPTION OF THE DRAWINGS

FIG. 1 is a perspective view of an embodiment of the writing instrument of the present invention.

FIG. 2 is a perspective view of an alternate embodiment of the writing instrument of the present invention.

### DESCRIPTION OF THE PREFERRED EMBODIMENT

Although the disclosure hereof is detailed and exact to enable those skilled in the art to practice the invention, the physical embodiments herein disclosed merely exemplify the invention which may be embodied in other specific structure. While the preferred embodiment has been described, the details may be changed without departing from the invention.

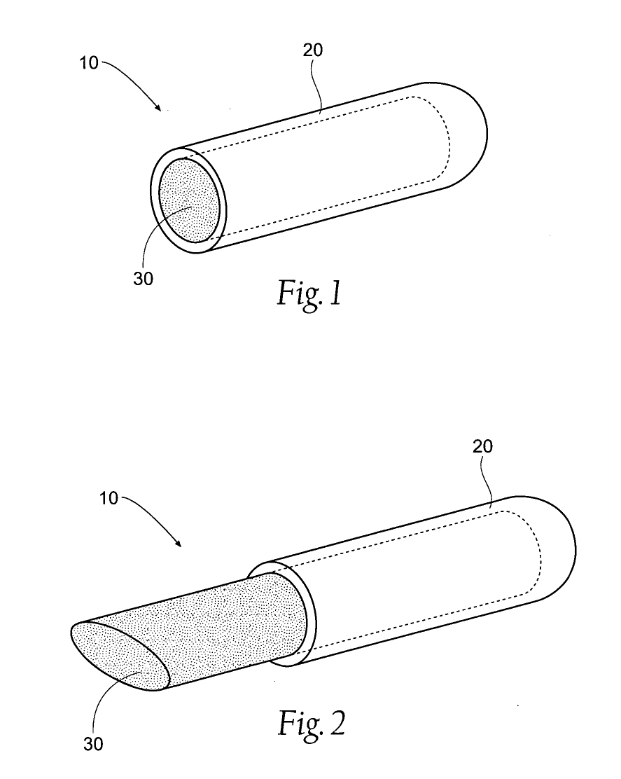

Referring now to FIG. 1, a perspective view of an embodiment of a writing instrument 10 is shown. In this embodiment, coating 20, which is preferably wax, is applied about the chalk or other substance 30. Application of the wax 30 can be accomplished through any means, such as dipping. This allows the chalk 30 to be held and used without the mess and feeling of chalk residue and stained clothing. For sidewalk chalk, the entire stick may be coated as shown, as the chalk 30 is deteriorated through use, so is the wax exterior 20. The wax 20 could be scented, but is preferably non-toxic and/or edible if desired for use by children.

Referring now to FIG. 2, a perspective view of an alternate embodiment of the writing instrument 10 of the present invention is shown. In this embodiment, well suited for blackboard chalk, such as in schools, only a portion of the chalk 30 would be coated with wax 20. This allows for application of the chalk 30 to a surface that is incompatible with wax. Blackboards and wax products would likely not be compatible without a wax removal product/eraser. However, an eraser similar to a shoe polisher sponge containing mineral spirits or WD-40 for wax removal could be provided (not shown).

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention.

1. A writing apparatus comprising:
a marking substance comprising chalk;
the marking substance being coated with a protective substance comprising wax.

2. The writing surface as claimed in claim 1 wherein said wax is scented.

3. The writing surface as claimed in claim 1 wherein said wax is nontoxic.

4. The writing surface as claimed in claim 1 wherein said wax is edible.
